(19) United States
(12) Patent Application Publication
(10) Pub. No.: US 2010/0148902 A1
(43) Pub. Date: Jun. 17, 2010

(54) SURFACE MOUNT TYPE POWER INDUCTOR

(76) Inventors: Jae Young Shin, Seongnam-Si Gyeonggi-Do (KR); Byung Moo Song, Seoul (KR); Sang Kyung Lee, Seoul (KR)

Correspondence Address: IPLA P.A., 3550 WILSHIRE BLVD., 17TH FLOOR, LOS ANGELES, CA, 90010, US

(21) Appl. No.: 12/159,764

(22) PCT Filed: Dec. 28, 2006
(86) PCT No.: PCT/KR2006/005823

§ 371 Date: Jun. 30, 2008

(30) Foreign Application Priority Data
Dec. 28, 2005 (KR) 10-2005-0131853
Dec. 28, 2006 (KR) PCT/KR2006/005823

(51) Int. Cl. H01F 17/04

(52) U.S. Cl. 336/90; 336/221

(57) ABSTRACT

Disclosed herein is a surface mount type power inductor which has an outer magnetic capsule integrated with a coil-wound inner core, and which thus has no air gap between the outer magnetic capsule and the inner core, and can maintain a large inductance L in a high current condition. In the inductor, a coil is wound a predetermined number of turns around the inner core formed from ferrite or magnetic metal. An outer magnetic capsule, molded from a magnetic powder, an insulation filler, a binder, and a lubricant, is provided to cover the inner core and the coil.

### TECHNICAL FIELD

The present invention relates to a surface mount type power inductor.

### BACKGROUND ART

With the emphasis of development of various electronic appliances towards slimness and high performance, power circuits for supplying power are also designed not only for high capacity but also for slimness and shortness. Particularly, as central processing units (CPUs) for use in personal computers have been being directed toward high capacity and high speed, their power consumption increasingly grows. In order to satisfy this requirement, power circuits are adapted predominantly to function as a switching regulator type rather than a conventional linear regulator type.

A power inductor, which is usually adopted for a power circuit, has a double core structure consisting, as shown in FIG. 1, of an inner core 10 around which a coil is wound a predetermined number of turns, and an outer core 20 encapsulating the inner core.

Between the inner core and the outer core is an air gap AG which is usually filled with electroconductive epoxy. Depending on the magnetic flux density caused by the coils, the air gap AG determines the electrical properties of the inductor. Decreased thickness of the air gap brings about an increase in magnetic flux density and thus in inductance L. A larger inductance L allows the coil to be wound a smaller number of turns. Therefore, the total length of the coil is shortened, resulting in a decrease in direct current resistance (DCR). Due thereto, however, the inductance L is reduced under conditions of high current.

A brief description of magnetic properties in the presence or absence of the air gap AG is given in Table 1, below. Magnetic saturation effected at a high magnetic intensity H (A/m) means that the inductor can be used at a high current.

TABLE 1

| | |
|---|---|
| Air Gap | High magnetic permeability, but magnetic |
| present | saturation effected at low H |
| Air Gap | Low magnetic permeability, but magnetic |
| absent | saturation effected at high H |

Consequently, the removal of the air gap from the power inductor is an ideal solution for the slimness and shortness, and high capacitance thereof if inductance L is not lowered under a high current condition. The advantageous effect by which the inductance L increases as the air gap is narrowed may be concurrent with a disadvantageous effect by which the inductance L decreases under a high current condition. In other words, an ideal power inductor can be embodied by overcoming the intrinsic technical contradiction (TC) in which the two contradictory effects act against each other.

### DISCLOSURE OF THE INVENTION

Accordingly, the present device has been made keeping in mind the above problems occurring in the prior art, and an object of the present device is to provide a surface mount type power inductor lacking an air gap, which has an outer magnetic capsule integrated with a coil-wound inner core and can maintain a high inductance L in a high current condition.

Another object of the present invention is to provide a surface mount type power inductor which has a coil wound a low number of turns around an inner core and thus decreased direct current resistance without reduction in inductance in a high current condition.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a longitudinal cross sectional view of a conventional power inductor;

FIG. 2 is a perspective view of a surface mount type power inductor according to the present invention;

FIGS. 3a and 3b are illustrative views showing inner cores useful in the present invention;

FIGS. 4a and 4b are illustrative views showing the inner cores around which a coil is wound in accordance with the present invention;

FIG. 5 shows longitudinal cross sectional views of a conventional inductor and an inductor according to the present invention;

FIGS. 6a and 6b are perspective views of surface mount type power inductors according to the present invention; and

FIGS. 7a and 7b are perspective views of surface mount type power inductors, equipped with external electrodes, according to the present invention.

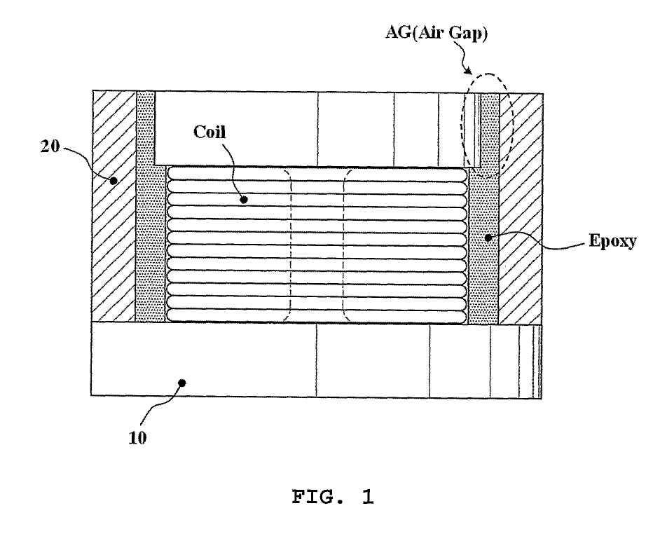

### BEST MODE FOR CARRYING OUT THE INVENTION

Herein below, a preferred embodiment of the present device will be described in detail with reference to the accompanying drawings. In the following description, where an explanation of some conventional function or conventional construction would impede the comprehension of the gist of the present device, the explanation may be deemed unnecessary.

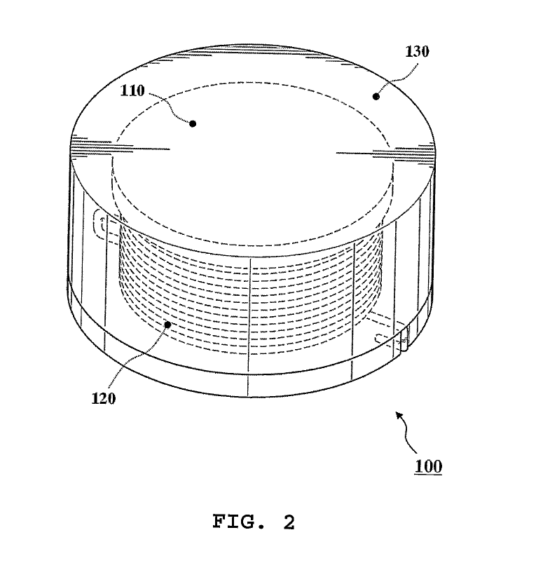

With reference to FIG. 2, a surface mount type power inductor (hereinafter referred to as “inductor”) 100 according to the present invention is shown. The inductor 100 comprises, as shown in FIG. 2, an inner core 110, a coil 120 wound in a predetermined number of turns around the inner core, and an outer magnetic capsule 130 covering the coil-wound inner core.

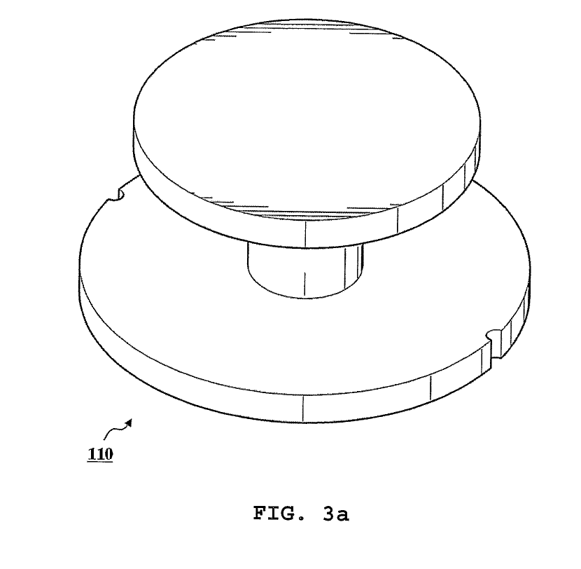

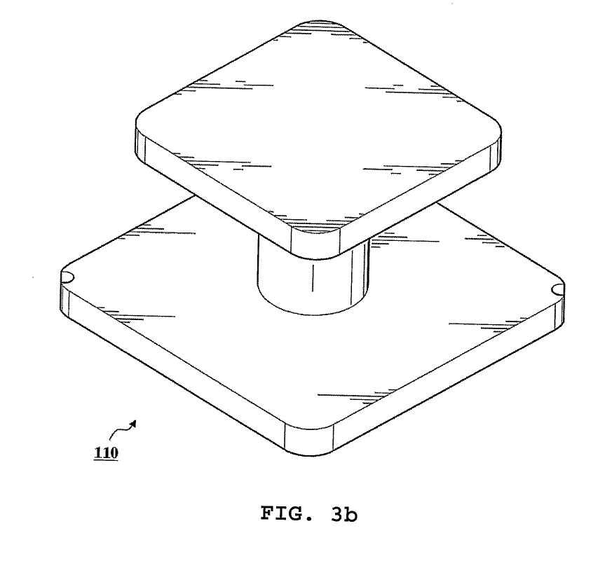

The inner core 110, made from ferrite or magnetic metal, may be formed into a circular drum type shown in FIG. 3a, a square drum type shown in FIG. 3b, a T type (not shown), or an I type (not shown).

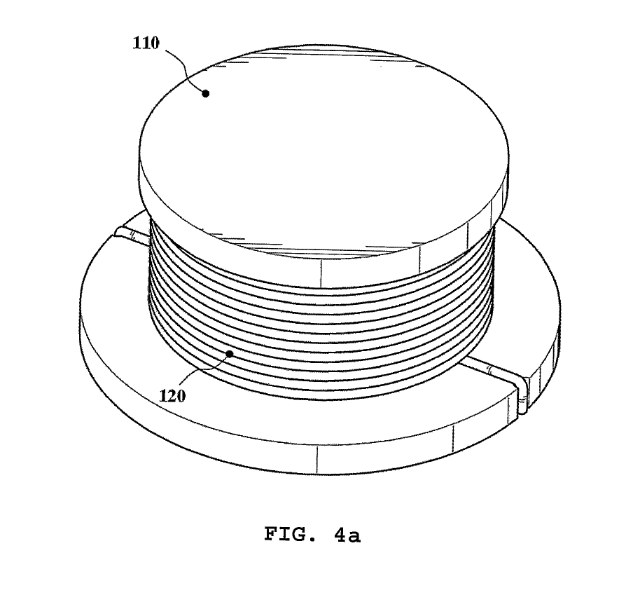

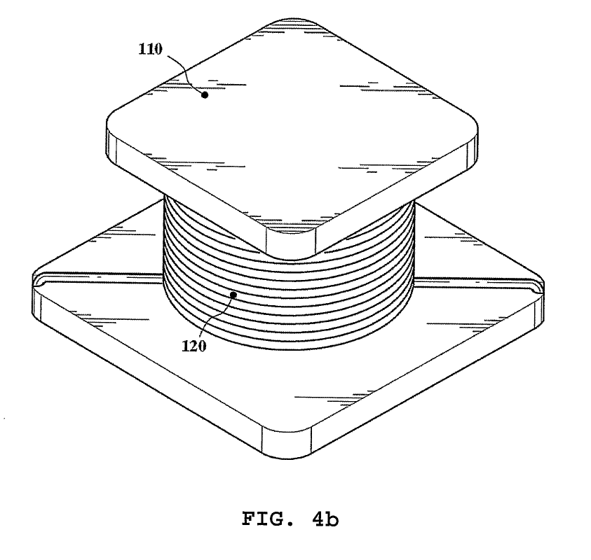

The coil 120, as shown in FIGS. 4a and 4b, is wound a predetermined number of turns around the inner core 110. It is coated with insulation resin. This insulation coating is preferably made from polyamide when the heat of the circuit is expected to be 125° C. or higher.

Exhibiting the technical feature of the present invention, the outer magnetic capsule 130 is formed from a magnetic powder, an insulation filler, a binder, and a lubricant using a molding process. Magnetic powder useful in the present invention may be exemplified by iron powder, permalloy powder, a sendust powder, an amorphous alloy powder, and a ferrite powder. It is preferable that the magnetic powder have a mean diameter of 30 μm or less. If the powder particles are large or have sharp edges, they are apt to break the insulation coating of the coil during the molding process (during which high pressure is usually applied).

The magnetic powder must be insulated to a predetermined level. Unless insulation is provided, eddy current loss occurs, incurring heat generation. Generally, the insulation of the magnetic powder can be effected by treating magnetic powder with phosphoric acid or with an inorganic binder such as water glass. The insulation can be achieved by various other methods, which are applicable to the present invention.

The insulation filler functions to improve the insulation of the magnetic powder and includes talc, MgO, CaO or mixtures thereof. This insulation filler is preferably used in an amount from 0.5 to 5% by weight based on the weight of the magnetic powder. Additionally, the binder is used to increase miscibility with the magnetic powder and is formed as a liquid phase in an organic solvent, such as alcohol or methylethylketone. The amount of the binder is preferably on the order of 1 to 6% by weight based on the weight of the magnetic powder. As the amount of the binder increases, the amount of insulation between magnetic powder particles grows. However, there are disadvantages of decreased permeability and low saturated magnetic flux density. The lubricant is used to improve the fluidity of the magnetic powder and the insulation filler within the mold, and may be selected from among stearic acid, zinc, calcium stearate, waxes and combinations thereof. The amount of the lubricant may be preferably on the order of 0.1 to 0.7% by weight based on the weight of the magnetic powder.

Integrated with the coil 120 and the inner core 110, the outer magnetic capsule 130 is suggested as a solution to the technical contradiction from which conventional inductor structures suffer. In other words, the problem, occurring upon the removal of the outer core 20 and air gap AG in conventional inductors, of decreased inductance L under a high current condition can be solved by the outer magnetic capsule 130 which exhibits a high saturated magnetic flux density in accordance with the present invention.

Also, the structure of the present invention can reduce the number of turns of the coil and thus the direct current resistance in addition to allowing inductance L to be kept at a high level under a high current condition.

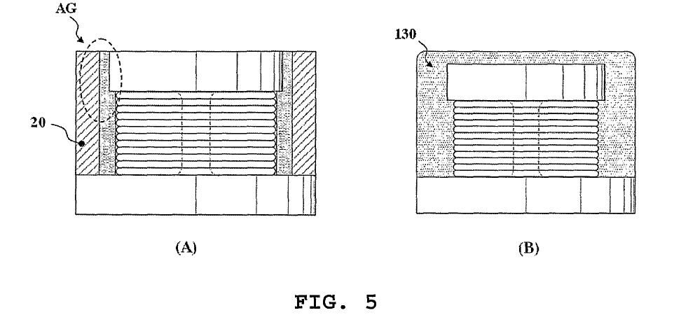

Referring to FIG. 5, the structure of the inductor (B) according to the present invention is compared to that of a conventional inductor (A).

The performance of the conventional inductor and the inductor of the present invention is summarized in Table 2, below. Each of the indicators has an inductance L of 4.4 uH and a dimension of 2.8mm×2.8 mm×1.0 mm. Whereas the conventional inductor is measured to have a direct current resistance (DCR) of 0.17Ω with 15 turns of the coil, the inductor of the present invention is measured to have a direct current resistance (DCR) of 0.096Ω with 10 turns of the coil.

TABLE 2

| | Conventional | Inventive |
|---|---|---|
| Inductance (L) | 4.4 uH | 4.4 uH |
| Dimension | 2.8 mm × | 2.8 mm × |
| | 2.8 mm × 1.0 mm | 2.8 mm × 1.0 mm |
| No. of Turns | 15 | 10 |
| DCR | 0.17Ω | 0.096Ω |

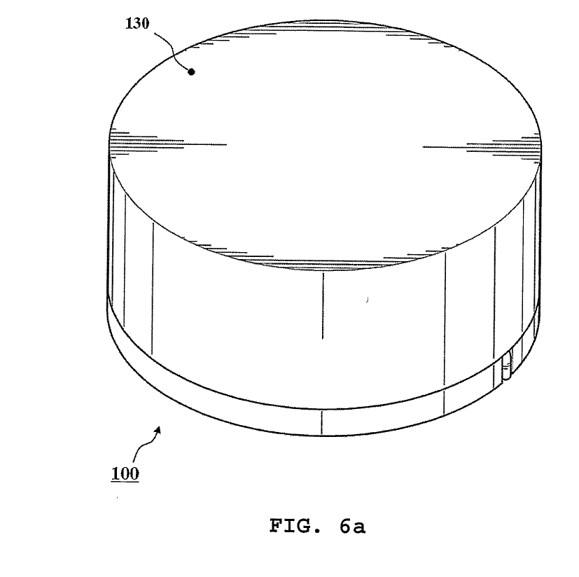

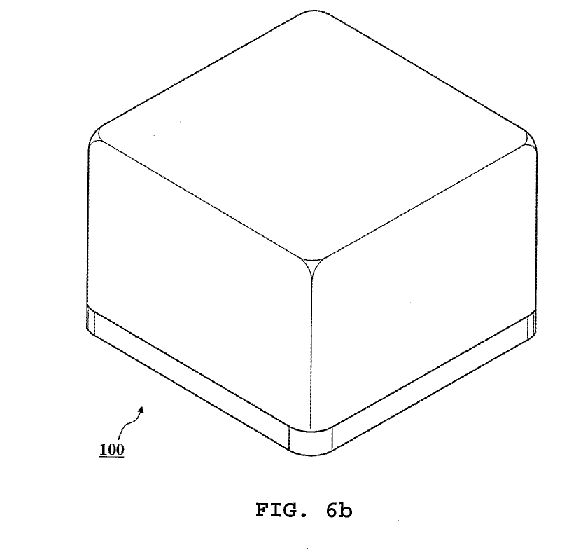

The inductor 100 of the present invention may be formed as shown in FIG. 6a or 6b. Preferably, when the inner core 110 is a square drum type, as described above, the inductor 100 of the present invention may be molded to have the form of FIG. 8.

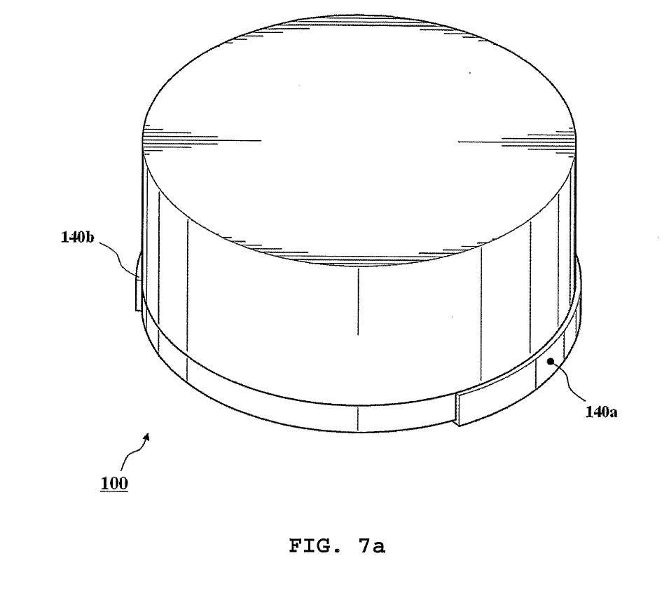

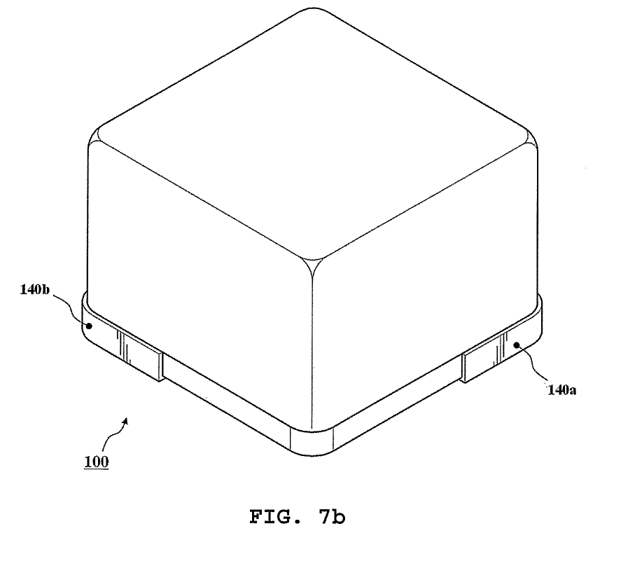

The inductor 100 may be equipped with external electrodes which form a junction with both ends of the coil. In this regard, silver pastes or electroconductive metal pieces may be applied to the lower end portion of the inductor. Illustrative, non-limiting examples of the latter case are depicted in FIGS. 7a and 7b, in which external electrodes 140a and 140b are formed from metal pieces at the lower end portions of the inductor.

### INDUSTRIAL APPLICABILITY

In the structure of the inductor according to the present invention, as described hitherto, the outer magnetic capsule integrated with the coil-wound inner core allows the elimination of the outer core and air gap, which are necessary in conventional inductor structures, and guarantees a high inductance L under a high current condition. Accordingly, the inductor of the present invention has a significantly reduced number of turns of the coil and a remarkably lowered direct current resistance compared to conventional inductors.

Although the preferred embodiments of the present invention have been disclosed for illustrative purposes, those skilled in the art will appreciate that various modifications, additions and substitutions are possible, without departing from the scope and spirit of the invention as disclosed in the accompanying claim.

1. A surface mount type power inductor, comprising:
an inner core, made from ferrite or magnetic metal, having a form selected from among an I type, a T type or a drum type,
a coil wound a predetermined number of turns around the inner core,
external electrodes communicating respectively with opposite ends of the coil, and
an external magnetic capsule, formed from a magnetic powder, an insulation filler, a binder, and a lubricant through a molding process, covering the inner core and the coil, said magnetic powder being selected from a group consisting of iron powder, permalloy powder, sendust powder, amorphous alloy powder, and ferrite powder.
